(19) United States
(12) Patent Application Publication
(10) Pub. No.: US 2018/0331904 A1
(43) Pub. Date: Nov. 15, 2018

(54) A WAY OF CONFIGURING A DEVICE FOR CONCEALED CONNECTION MERGING THROUGH COORDINATED AND DYNAMIC VIRTUAL PROXY ALLOCATION

(71) Applicant: SWAG TECHNOLOGIES SDN BHD, KL Sentral, Kuala Lumpur (MY)

(72) Inventors: Raphael MANNADIAR, KL Sentral, Kuala Lumpur (MY); Rami ALADDIN, KL Sentral, Kuala Lumpur (MY); Farhash Wafa SALVADOR, Kuala Lumpur (MY)

(21) Appl. No.: 15/773,733

(22) PCT Filed: Nov. 5, 2015
(86) PCT No.: PCT/MY2015/000094

§ 371 Date: May 4, 2018

(51) Int. Cl. H04L 12/24; H04L 29/06

(52) U.S. Cl. CPC H04L 41/0816; H04L 65/105; H04L 41/0886; H04L 41/12; H04L 65/605

(57) ABSTRACT

The present invention describes a way of configuring an existing, conventional network-enabled device by modifying and augmenting its designs, schematics, hardware and/or software, and by integrating it into a system, resulting in a corresponding augmented device capable of demand-driven, flexible topology and intelligently-enabled communication between said resulting augmented device and at least one conventional network-enabled application server over multiple segments of the Internet concurrently. The augmented device is configured so as to possess a processing unit, a memory unit, a storage unit, as well as two or more mobile broadband access devices. The augmented device is configured to coexist and cooperate with the other components of the system.

### FIELD OF THE INVENTION

The present invention relates generally to network communication systems; and more particularly to the coordination of dynamic pools of Internet proxies and devices capable of using them.

### BACKGROUND

The bandwidth of mobile broadband has seen exponential improvements over the past decades. However, due to the technical particularities of mobile broadband technologies (e.g., 2G GSM/GPRS/EDGE, 3G WCDMA/HSPA+/DC-HSPA+, 4G LTE/WiMAX, 5G LTE-A, etc.), they have always been and continue to be far slower and far more expensive per-Gigabyte-of-usage than wired Internet access technologies (e.g., ADSL, VDSL, Cable, Fibre-optic, etc.).

Mobile broadband technologies transport Internet traffic via a subset of the radio spectrum. Only relatively narrow portions of the entire radio spectrum have conventionally been reserved for consumer mobile broadband technologies, and obtaining the legal rights to transmit and receive on said portions of the radio spectrum has conventionally been an extremely expensive process. Furthermore, the disjoint portions of radio spectrum, called “frequency bands”, reserved for consumer mobile broadband technologies (e.g., 800 MHz band, 2100 MHz band, 2600 MHz band, etc.) are fractured into disjoint “frequency band channels”.

These factors contribute to the relatively low bandwidths and high prices of mobile broadband technologies in comparison to wired Internet access technologies. A very limiting factor to the bandwidth of any mobile broadband technology is the width of the conventionally narrow frequency band channel it operates on. Modern research into improving mobile broadband technologies revolves around altering mobile broadband infrastructures (and consequently any device intended to access said infrastructures) in order to support the utilization of multiple of the limited frequency band channels simultaneously by a single device, and improving the efficiency of data transport and signal encoding technologies. Both approaches are conventionally extremely costly and lengthy to deploy given that software and/or hardware modifications need to be physically carried out at every single cellular base station. Moreover, only the latest of consumer devices can conventionally make use of the latest mobile broadband technologies.

Mobile broadband technologies do hold some advantages over wired Internet access technologies though: they are conventionally already available and/or less costly to deploy in rural areas, in developing countries, in moving vehicles, etc.; all contexts where wired Internet access technologies are often either challengingly expensive or downright impossible to deploy and/or maintain.

Merging the bandwidths of multiple network connections has been a topic of academic and commercial research for decades. Merged network connections can offer higher-bandwidth and increased robustness to individual connection failures. Numerous software and hardware, academic and commercial “connection-merging solutions” have been invented which offer varying levels of improved bandwidth and/or reliability, and varying levels of support for transporting existing network protocols (e.g., TCP, UDP, ICMP, etc.). However, a common and seemingly unavoidable limitation across all solutions is that both end-points (e.g., communicating client devices and application servers) must undergo software and/or hardware upgrades to support the connection-merging solutions. Some efforts have proposed solutions where portions of the network infrastructure between end-points undergo software and/or hardware upgrades to enable the end-points to benefit from merged network connections without being altered themselves. These solutions are conventionally not portable, are limited in scope and flexibility, and do not scale to real-world scenarios where client devices and application servers may be geographically scattered and exist in arbitrarily high numbers. Moreover, most of these “connection-merging solutions” operate on Layer 3 (the Network Layer) of the Open Systems Interconnection (OSI) model and as such encounter limitations when the “merged” connections' individual bandwidths and/or latencies are heterogeneous. This limitation is especially relevant in the context of merging mobile broadband connections: not only does the performance of mobile broadband connections based on different mobile broadband technologies or infrastructures vary massively, at a finer granularity, so does the bandwidth and latency of a single mobile broadband connection over time, because of congestion, and over space, because of heterogeneous coverage.

### SUMMARY OF THE INVENTION

The present invention addresses the aforementioned needs and issues by providing a way of configuring a conventional network-enabled device (e.g., smartphone, tablet, laptop, mobile WiFi hotspot, etc.) in a system, resulting in an augmented device 100 capable of communication with one or more conventional network-enabled application servers 103 over multiple segments of the Internet concurrently.

In practice, the augmented device 100 communicates with said application servers 103 over several disjoint mobile broadband infrastructures of several distinct network operators, and as a result offers increased bandwidth, increased reliability, increased stability and an increased coverage compared to conventional, single-operator mobile broadband communication.

Said increases in bandwidth, reliability, stability and coverage are in part enabled by the use of Layer 4 (the Transport Layer) of the Open Systems Interconnection (OSI) model, which allows the traffic to be distributed optimally among the individual mobile broadband connections in real time according to their bandwidths and latencies, regardless of the severity of the disparities between said bandwidths and latencies, as well as the severity of the disparity between the bandwidth and latency of each individual connection over time due to congestion, and over space due to heterogeneous coverage.

Additionally, and in order to obtain these enhancements in a scalable, demand-driven and cost-effective fashion without the need to modify the conventional network-enabled application servers 103 or the network infrastructure that stands between them and the augmented device 100, a coordination machine 104 manages the number and performance attributes of a pool of relay machines 102 that act as proxies between said augmented device 100 and said application servers 103.

Hardware-wise, the augmented device 100 is equipped with two or more mobile broadband access devices 101, each of which connects to a mobile broadband network using a distinct digital identity. The mobile broadband access devices 101 are configured and programmed to utilize distinct frequency band channels 402 whenever possible such as to maximally reduce the likelihood of the mobile broadband access devices 101 competing for the same network resources (e.g., network capacity and bandwidth of a single frequency band channel 402) as well as to minimize the likelihood of interference between the mobile broadband access devices 101, in practice, this is achieved by equipping each of the mobile broadband access devices 101 with a digital identity that grants them access to the network of a distinct operator.

Software-wise, the augmented device 100 is equipped with the necessary programs to support the connection-merging protocol, to intercept conventional outgoing or transiting Internet requests intended for an application server 103, and to modify them such that they use said connection-merging protocol to transit through one of the relay machines 102. Additionally, the software on the augmented device 100 allows it to communicate with the other components in the system, and in particular, it allows the augmented device 100 to be attributed said one relay machine 102 by the coordination machine 104.

The disclosed hardware and software configuration is not only intended for novel designs, but is also intended to be applied to the existing designs, schematics and software of arbitrary conventional network-enabled devices (e.g., smartphones, tablets, laptops, mobile WiFi hotspots, etc.) to enhance their mobile broadband communication capabilities. In the preferred embodiment, a conventional smartphone's design is altered to augment it with one or more mobile broadband access devices 101, and the software on said smartphone is altered to add support for the connection-merging protocol and for collaboration with the other components in the system. Said alterations, from the user's perspective, do not result in any noticeable changes in the behavior and interface of the augmented smartphone 100, but allow for greatly improved mobile broadband communication.

### BRIEF DESCRIPTION OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings.

FIG. 1 depicts all the elements of the disclosure's system at a high-level, as well as their network topology in the invention's preferred embodiment;

FIG. 2 is a close-up on an exemplary augmented smartphone 100, exposing its hardware components in the invention's preferred embodiment;

FIG. 3 is a close-up on the mobile broadband component of the Internet infrastructure that connects an exemplary augmented smartphone 100 and an exemplary relay machine 102 in the invention's preferred embodiment;

FIG. 4 is a close-up on the software elements encountered by network data flowing between an exemplary application 210 running on an exemplary augmented smartphone 100 and an exemplary application server 103 in the invention's preferred embodiment;

FIG. 5 depicts all the elements of the disclosure's system at a high-level, as well as their network topology in an alternate embodiment of the invention where an exemplary augmented device 100 (e.g., smartphone, tablet, laptop, mobile WiFi hotspot, etc.) acts as a hotspot or Internet gateway for exemplary client devices 300;

FIG. 6 is a close-up on the software elements encountered by network data flowing between an exemplary client device 300 and an exemplary application server 103, in an alternate embodiment of the invention where an exemplary augmented device 100 (e.g., smartphone, tablet, laptop, mobile WiFi hotspot, etc.) acts as a hotspot or Internet gateway for said exemplary client device 300.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and the claims to refer to particular features or components. As one skilled in the art will appreciate, different persons may refer to the same features or components by different names. This document does not intend to distinguish between components or features that differ in name but not in function. Objects displayed in the figures and drawings are not always in proportion to one another, this may be for convenience or to focus on the essential parts of the disclosure.

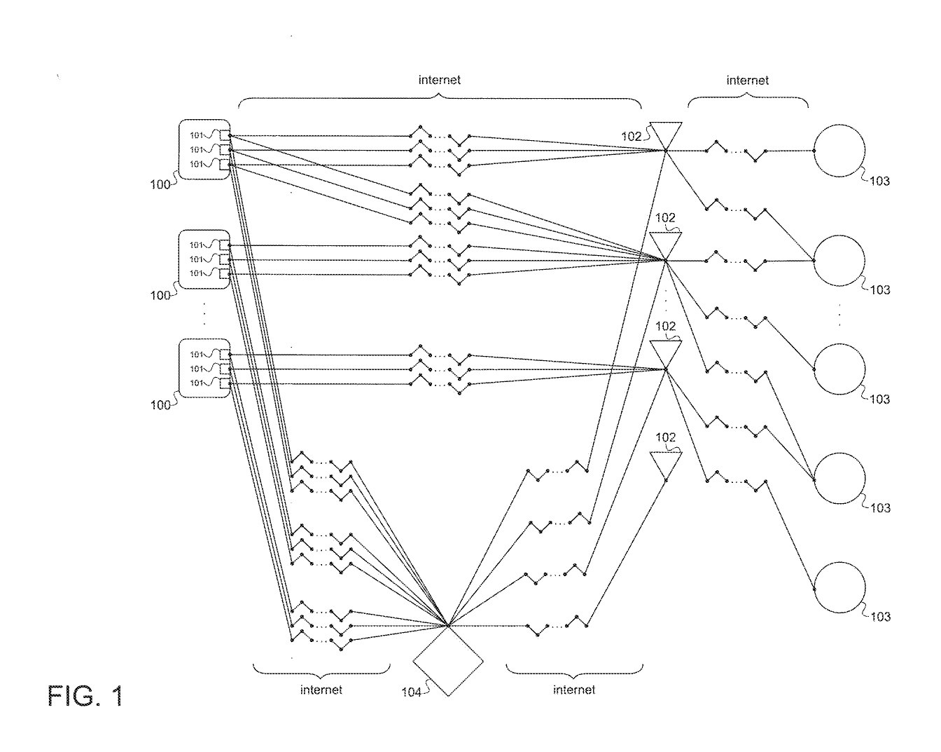

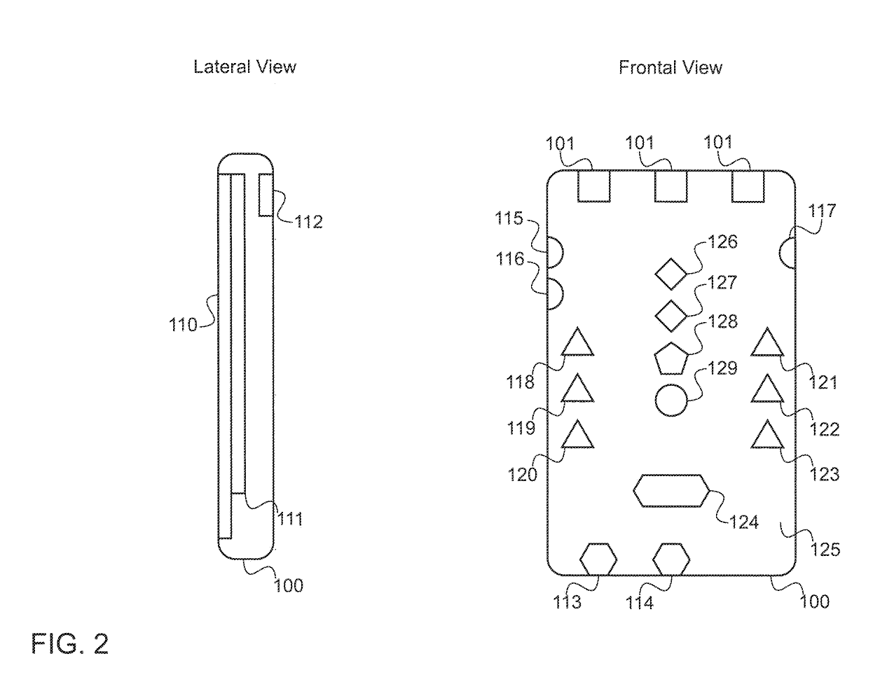

Disclosed is a way of configuring an existing, conventional network-enabled device (e.g., smartphone, tablet, laptop, mobile WiFi hotspot, etc.) by modifying and augmenting its designs, schematics, hardware and/or software, resulting in an augmented device 100 which possesses specific hardware and software capabilities and is configured to be part of and interact with a number of components in a system. These alterations allow demand-driven, flexible topology and intelligently-enabled communication between said augmented device 100 and at least one conventional network-enabled application server 103 over multiple segments of the Internet concurrently. The augmented device 100 is shown in FIGS. 1 and 2 in the preferred embodiment of the invention, where said augmented device 100 is an augmented smartphone 100. FIG. 1 also shows the pool of relay machines 102 which serve as proxies between the augmented devices 100 and the application servers 103 as well as the coordination machine 104 which allows the number and characteristics of active relay machines 102 to scale up and down, as a function of demand, in order for the system to be economically viable. In the following the description first details the augmented device 100 and its configuration, then expands on the connection-merging protocol that allows the exchange of a single stream of data over multiple segments of the Internet concurrently, and finally focuses on the relay machines 102 and the coordination machine 104, as well as their role in the configuration and operation of the augmented device 100.

It is important to note that what is meant by “a single stream of data” is a set of data units that is conventionally exchanged between two end-points over a single Internet connection, originating from a single Internet Protocol (IP) address and destined to another single IP address, regardless of whether said data units are sequenced or unsequenced and regardless of whether or not, when combined, they produce a single coherent data item.

In the preferred embodiment and in most of the following description, the augmented device 100 is a smartphone as known in the art, augmented with the necessary hardware and software capabilities which are detailed below. It should be understood however that the invention is applicable to a great variety of other portable and non-portable network-enabled devices (e.g., tablets, laptops, mobile WiFi hotspots, desktop computers, etc.). And while a plurality of such examples will be given later on in this, document, it should be understood that the scope of the invention is not limited by these examples.

Hardware-wise, and as shown in FIG. 2, the augmented smartphone 100 is configured to be equipped with all the components that make up a conventional smartphone as known in the art; it contains a circuit board 125 to which all of the following components are either mounted on or connected to: a touchscreen sensor 110, a display 111, a camera 112, an audio input and output port 113, a power input and USB port 114, physical interfaces for increasing 115 as well as decreasing 116 the volume, a physical interface for turning the device on or off 117, a microphone 118, a speaker 119, a GPS 120, a WiFi adapter 121, a Bluetooth adapter 122, an Infrared adapter 123, a rechargeable battery 124, a processing unit 126, a graphics processing unit 127, a memory unit 128 and a storage unit 129. Additionally, and unlike conventional smartphones as known in the art, the augmented smartphone 100 is equipped with not one but two or more mobile broadband access devices 101, each of which is equipped with its own digital, physical or virtual identity (e.g., subscriber identity module (SIM) card, WIMAX credentials, etc.).

It is important to note that what is meant by “a mobile broadband access device” 101 is a set of all the components that make up a fully-functioning mobile broadband modem, including but not limited to one or more of the following: a power management unit, a processing unit, one or more antennas, a SIM card slot, etc. And while some existing devices possess separate modules for 3G and 4G connectivity, equipment sharing the same digital identity or equipment that is designed to complement each other's functionality, as opposed to designed to operate simultaneously, is considered to make up a single mobile broadband access device 101. What is meant by “the augmented smartphone 100 is equipped with two or more mobile broadband access devices 101” is that the augmented smartphone is equipped with two or more fully functional, independent mobile broadband communication modules or independent sets of mobile broadband communication modules, each using its own digital identity, each being able to operate independently of one another, and all of which are designed and arranged so as to operate simultaneously.

As a result of the increase in the number of mobile broadband access devices 101, more radio frequency (RF) emissions and as a result more interference, is observed. As such, the mobile broadband access devices 101 are spread as far and wide across or opposite the printed circuit board 125 as possible in the augmented smartphone 100 configuration so as to maximally limit interference between each of them when they are operating simultaneously, as well as interference between each of them and the WiFi adapter 121 when said adapter is also operating. Additionally, isolating elements are inserted around the WiFi adapter 121 and between each pair of mobile broadband access devices 101 to isolate and shield them from one another's RF emissions. Said isolating elements are made of sheet metal, preferably copper, and a subset of said elements contains holes distributed over their surface in a mesh-like pattern. In order to effectively isolate the different components, said holes are sized to be much smaller than the wavelength of the emitted radio frequencies. It is important to note however, that the likelihood of interference is lowered by the fact that the mobile broadband access devices 101 are configured and programmed to utilize distinct frequency band channels 402 whenever possible such as to maximally reduce the likelihood of the mobile broadband access devices 101 competing for the same network resources, as explained further below.

In addition to the interference concerns, and because of the presence of two or more mobile broadband access devices 101 that need to operate simultaneously instead of one in conventional smartphones, an increase in power consumption and heat generation is observed. As such, several adjustments are performed to the layout and capacity of the power management components, and the augmented smartphone 100 is equipped with a battery that possesses a superior capacity, chosen such that the achieved C-rate is, at worst, equal to that of the original version of the smartphone. Furthermore, and similarly to the above methods to account for an increase in RF emissions, the mobile broadband access devices 101 are spread as far and wide across or opposite the printed circuit board 125 as possible in the augmented smartphone 100 configuration so as to limit heat transfer as well as heat build-up, as air and the grade four flame retardant (FR-4) glass epoxy that makes up the non-conductive portion of the printed circuit board are effective means for limiting thermal conduction between the different components of the augmented smartphone 100.

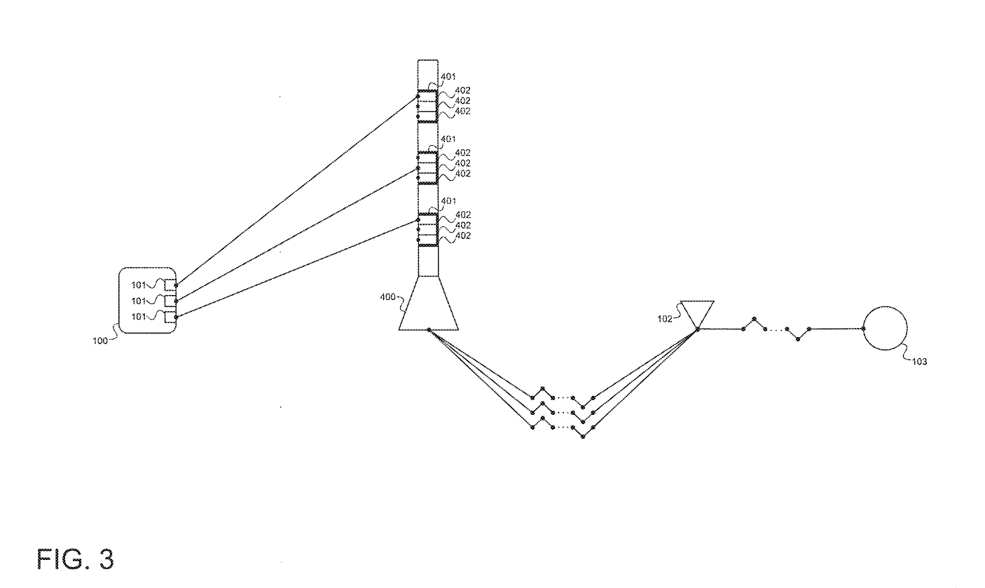

In the preferred embodiment, the augmented smartphone 100 is configured such that the digital identities used by the mobile broadband access devices 101 are SIM cards, and each mobile broadband access device 101 is associated with and uses a single SIM card to gain access to a mobile network. As depicted in FIG. 3, in order to maximally reduce the likelihood of the mobile broadband access devices 101 competing for the same network resources as well as to minimize the likelihood of interference between the mobile broadband access devices 101, the augmented smartphone. 100 is additionally configured such that the mobile broadband access devices 101 explicitly connect to distinct frequency band channels 402 of possibly distinct frequency bands 401 on possibly the same cellular base station 400. In this configuration, each of the mobile broadband access devices 101 can potentially access the entire bandwidth of the frequency band channel 402 it connects to and the total bandwidth accessible by all of the mobile broadband access devices 101 equals the sum of the available bandwidths of each of the connected-to frequency band channels 402, and is thus larger than the available bandwidth of any individual connected-to frequency band channel 402. Conversely, and illustrative of the aforementioned competition for network resources, if two or more of the mobile broadband access devices 101 were to connect to the same frequency band channel 402, the total bandwidth accessible by said mobile broadband access devices 101 would be at most as large as the available bandwidth of said individual frequency band channel 402.

In the preferred embodiment, this behavior is achieved by configuring the augmented smartphone 100 such that the digital identities used by the mobile broadband access devices 101 are SIM cards that provide access to the mobile networks of distinct operators. For the reasons detailed above, these operators are chosen so as not to share spectrum or infrastructure and as such and for instance, are chosen not to simultaneously comprise of a mobile virtual network operator as well as its host mobile network operator. By doing so, it is guaranteed that the likelihood that two or more of the mobile broadband access devices 101 are sending and/or receiving data on the same frequency band channel 402, and, as a consequence, the likelihood that two or more of the mobile broadband access devices 101 are competing for the same spectrum and associated bandwidth, is minimized. Additionally, the likelihood of the augmented smartphone 100 being subject to the effects of connection-dropping, bufferbloat, or extremely high congestion at the base station changes from the likelihood of one of those events occurring on one operator's infrastructure, to the likelihood of one of those events occurring simultaneously on two or more operators' infrastructures.

As a result of this hardware configuration and augmentation, the augmented smartphone 100 is equipped with all the necessary hardware components to simultaneously connect to the Internet using two or more mobile broadband access devices 101. However, conventional network protocols (e.g., TCP, UDP, ICMP, etc.) which are used by conventional applications 210 (e.g., web browser, smartphone app, computer program, etc.) running on conventional end-user devices as well as application servers 103 do not allow the exchange of a single stream of data over several distinct Internet connections (with distinct sets of IP addresses). The steps of the device and system configuration disclosed below allow the augmented smartphone 100 to benefit from the use of several distinct Internet connections when exchanging a single stream of data with an arbitrary application server 103, without the need to alter said application server 103. As such and in the following, the description details the software configuration of the augmented smartphone 100 and namely the connection-merging protocol it implements, later on expands on the relay machines 102 that hide said configuration and protocol from the conventional application servers 103 which do not support them, and finally focuses on the coordination machine 104 which allows the system to be scalable and industrially applicable by intelligently scaling the size and capacity of the pool of relay machines 102 based on demand in order to minimize the cost overheads of using the augmented smartphone 100 compared to its conventional counterpart.

Software-wise, the augmented smartphone 100 is configured such that network data sent and received by an arbitrary software application 210 (e.g., web browser, smartphone app, computer program, etc.) running on said augmented smartphone 100 to and from an arbitrary application server 103 (e.g., Facebook, Google, etc.) transits through a relay machine 102 which serves as a proxy for the augmented smartphone 100. The relay machine 102 respectively receives and sends said data from and to the augmented smartphone 100 over all of said augmented smartphone's 100 network connections, available through its different mobile broadband access devices 101, and respectively sends and receives said data to and from the application server 103 over a single high-speed landline connection. The data sent and received by the software application 210 and by the application server 103 is sent and received using an original protocol (e.g., TCP, UDP, ICMP, etc.), while the data exchanged between the augmented smartphone 100 and the relay machine 102 uses a connection-merging protocol. Both the augmented smartphone 100 and the relay machine 102 are configured to understand and implement said protocol; as a result, when said software application 210 running on the augmented smartphone 100 exchanges network data with the application server 103, the augmented smartphone 100 and the relay machine 102 exchange a single stream of data over several mobile broadband access devices 101 simultaneously, yielding a higher bandwidth and increased reliability compared to conventional, single-mobile-connection communication.

In order to minimize the perceptible software changes and to achieve a transparent user experience, the software configuration of the augmented device 100 resides at the operating system level and is completely transparent to the software applications 210. As such, in the preferred embodiment, the augmented smartphone 100 is configured to run a modified version of the Android operating system for which all of the conventionally available, unmodified Android applications 210 function without any required changes. As explained further below when the flow of network data is described, said applications 210 perform the same network requests using the same conventional network protocols (e.g., TCP, UDP, ICMP, etc.), and said requests are then intercepted transparently at the operating system level and modified so as to proxy through the relay machine 102 using the connection-merging protocol. While the preferred embodiment is an augmented smartphone 100 running a modified version of the Android operating system, several different embodiments do or do not require the use of a transparent or operating system-level implementation of the software as detailed below.

Last but not least, the augmented smartphone 100 is configured so as to be able to communicate with a central coordination machine 104. The communication between the augmented smartphone 100 and the coordination machine 104 follows a simple but essential protocol, and, as explained below when the behavior of the coordination machine 104 is described in more detail, the augmented smartphone 100 cannot achieve any of the above functionality without communicating with the coordination machine 104 and receiving the identity of (e.g., IP address, domain name, etc.) as well as a set of corresponding credentials for authentication with (e.g., username, password, certificates, etc.) its assigned relay machine 102. The relay machine 102 assigned to the augmented smartphone 100 by the coordination machine 104 is requested by the augmented smartphone 100 upon establishing an Internet connection, and is thereafter updated following the coordination machine's 104 instructions. Finally, the augmented smartphone 100 is configured to regularly communicate with the coordination machine 104 to exchange usage, bandwidth, latency and location information with it to allow said coordination machine 104 to perform its intended function, which is detailed below. In the preferred embodiment of this invention, and in order to maximize the speed and reliability of said exchanges of information between the augmented to smartphone 100 and the coordination machine 104, the coordination machine is configured to understand the connection-merging protocol used by the augmented smartphone 100 and the relay machines 102, and all communication between the augmented smartphone 100 and the coordination machine 104 is performed using the connection-merging protocol.

In the following, the description details the connection-merging protocol that allows the augmented smartphone 100 to exchange a single stream of data with a relay machine 102 using two or more mobile broadband access devices 101 simultaneously, later on expands on the relay machines 102 which allow the augmented smartphone 100 to benefit from the simultaneous use of two or more mobile broadband access devices 101 while exchanging a single stream of data with a conventional application server 103, and finally focuses on the coordination machine 104 which allows the entire system to be scalable and demand-driven and in doing so allows the use of the augmented smartphone 100 to be economically viable and less resource intensive.

As explained above, the augmented smartphone 100 and the relay machines 102 need to be configured so as to communicate using a connection-merging protocol. As of this writing, there exists a number of connection-merging protocols that enable communication between specialized network-enabled client devices and specialized network-enabled application servers over multiple specialized or conventional segments of the Internet concurrently. Conceptually, connection-merging protocols can “merge” several Internet connections into a macro connection. The purpose of such connection-merging is to combine the bandwidth and/or reliability of the individual connections, or to otherwise improve upon one or more metrics of the individual connections. A commonly recurring means of realizing this purpose is to send intersecting or non-intersecting subsets of the data being exchanged over each of the two or more individual connections by prioritizing those individual connections that provide such properties as higher bandwidths, higher reliability, lower operating costs, lower latencies, etc. Said subsets are subsequently reassembled into the original data at the other end to simulate the existence of one said abstract macro connection.

Conventionally, these solutions involve the use of connection bonding at Layer 3 (the Network Layer) of the Open Systems Interconnection (OSI) model, and conventionally, these solutions are focused on load-balancing or redundancy rather than on providing the aforementioned improvements in throughput and coverage for the exchange of a single stream of data from a single user or device 100 to a single application server 103. In the context of mobile broadband, and especially when using several mobile broadband technologies and/or infrastructures simultaneously, there are severe disparities between the bandwidths and latencies of the different connections, but also between the bandwidths and latencies of a single connection over time, because of congestion, and over space, because of heterogeneous coverage. The severity of these disparities can make the use of conventional Layer 3 solutions such as bonding impractical or detrimental as these were developed in the context of merging identical and stable (in bandwidth and in latency) cable-based Internet connections. The enhancements our invention allows are in part made possible by the use of Layer 4 (the Transport Layer) of the Open Systems Interconnection (OSI) model by the connection-merging protocol, allowing the traffic to be distributed optimally among all available connections in real time according to the current bandwidth and latency of each of said connections, regardless of the severity of the disparities discussed above, to achieve a lossless amalgamation of the capacity and coverage of two or more distinct mobile broadband technologies or infrastructures.

Conventional Layer 3 connection-merging solutions like bonding typically only expose a single virtual network connection (instead of the underlying two or more networks connections) to the Layer 4 transport protocol (e.g., TCP, UDP, ICMP, etc.) that is used to manage the exchange of network data. As a result, said transport protocol, regardless of its nature or implementation, only has access to the network properties (e.g., latency and bandwidth) of the single virtual connection, and is unable to optimally manage the distribution of network traffic on each of the two or more underlying network connections individually. It should be understood however that this factorization and so called limitation is by design, since said Layer 3 connection-merging solutions were built under the assumption that as well as in the view of being used in situations where the two or more merged connections have identical properties (e.g., latency and bandwidth). On the other hand, Layer 4 connection-merging solutions are transport protocols that have direct access to the two or more network connections, and they manage the distribution of network traffic on each of said connections according to their individual network properties; as a direct consequence, these Layer 4 solutions are able to losslessly amalgamate the bandwidths of said individual connections even in situations where Layer 3 solutions cannot.

Another limitation of existing connection-merging protocols as of this writing is that both communicating end-point network devices (i.e., the user devices but more importantly the application servers 103) are required to implement the connection-merging protocol. A core function of the system formed by the augmented smartphones 100, the relay machines 102 and the coordination machine 104 is to overcome this limitation in a dynamically-calibrated manner to enable augmented smartphones 100 and any conventional network-enabled application server 103 (e.g., Facebook, Google, etc.) to communicate while benefiting from the enhanced properties of the macro connection over any of the individual connections it merges, without the need for said application servers 103, or the Internet infrastructure the data transits through, to be modified to implement the connection-merging protocol.

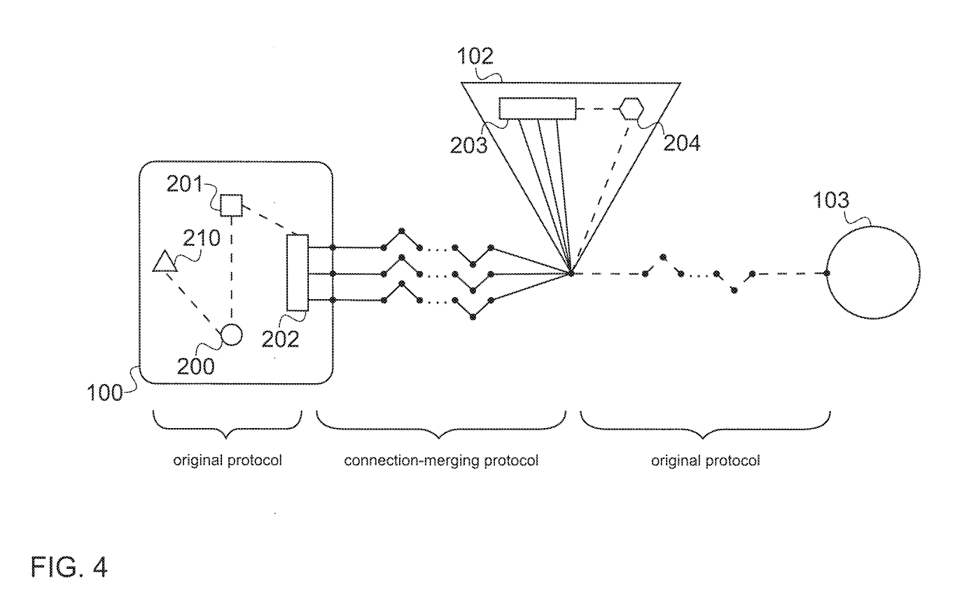

In order for the augmented smartphone 100 to be able to exchange a single stream of data with a conventional application server 103 while benefiting from the use of several mobile broadband access devices 101, and in particular several mobile infrastructures, simultaneously, relay machines 102 are used. The relay machines 102 operate in the cloud and act as amalgamating proxies that hide the connection-merging protocol from said conventional application servers 103. As illustrated in FIGS. 1 and 4, when an application 210 running on the augmented smartphone 100 exchanges information with an application server 103, the only portion of the Internet that uses the connection-merging protocol is the portion between the augmented smartphone 100 and the relay machine 102, which is typically the only portion that runs over mobile broadband infrastructure. The stream of information's original protocol is restored on each end by both the augmented smartphone 100 and the relay machine 102 before it respectively reaches the application 210 and the application server 103.

In order for the intermediate step introduced by each relay machine 102 in the flow of exchanged data to have as little a negative effect on the bandwidth and latency of the macro-connection as possible, it is crucial that each relay machine 102 has a broadband connection with as small a latency as possible, and it is crucial that each relay machine 102 be located as close as possible geographically to the augmented smartphones 100 proxying their traffic through them in order to limit said introduced latency further. Additionally, it is crucial that each relay machine 102 dedicates to each of its connected augmented smartphones 100 an amount of upload and download bandwidths that are both equal to the summed upload and download bandwidths over all of said augmented smartphone's 100 mobile broadband access devices' 101 corresponding mobile broadband connections at any given time. This guarantees that said relay machine's 102 broadband connection's bandwidth doesn't act as a bottleneck and that said augmented smartphone's 100 macro connection amalgamates all of its individual connections' bandwidths losslessly.

These crucial properties (both the geographical proximity as well as the dedicated amount of bandwidth) are guaranteed to be met optimally by the coordination machine 104 which operates in the cloud and whose role is indispensable to the well-functioning of the system. More generally speaking, the coordination machine 104 and its functions are indispensable in order to make any such proxy architecture both scalable and performant. The coordination machine 104 aggregates usage and performance information (e.g., geographical location, latency and bandwidth of available broadband connections, CPU utilization, memory and disk availability, etc.) sent to it by the relay machines 102 and the augmented smartphones 100, and uses said information along with a set of metrics to determine the required number of relay machines 102, as well as their optimal location and performance requirements in order to meet the crucial properties that allow the system and as a consequence the augmented smartphones 100 to function optimally, all the while minimizing the associated cost of operating the pool of relay machines 102.

In order to achieve this behavior, the coordination machine 104 has the ability to dynamically launch, configure and terminate relay machines 102 according to cost and performance metrics, as well as the ability to dynamically instruct each of the augmented smartphones 100 as to which of the relay machines 102 to proxy their Internet traffic through. While the coordination machine 104 ensures maximal geographical proximity between each pair of augmented smartphone 100 and associated relay machine 102, as well as the correct dedicated amount of bandwidth by each relay machine 102 for each of its associated augmented smartphones 100, the coordination machine also minimizes the total number of running relay machines 102 and does so by maximizing the network, CPU and memory load borne by each of the relay machines 102 at any given time, according to a set of metrics. Since the cost in operating such a system, and in turn the cost overhead introduced by the use of this novel technology and augmented smartphone 100 to the mass market, resides mainly in the number of operating relay machines 102, the coordination machine 104 effectively single-handedly renders the use of such a proxy architecture demand-driven, scalable and commercially viable for use at a larger scale.

After having detailed both the hardware and software configuration of the augmented smartphone 100, and in turn the interaction of said augmented smartphone 100 with both the relay machines 102 and the coordination machine 104 which make up the remaining components of the system illustrated in FIGS. 1 and 2, the description now focuses on FIG. 4 and looks at the detailed flow of network data that yields the aforementioned mobile connectivity enhancements. FIG. 4 shows the flow of network data between the different software elements of the invention when data is exchanged between an exemplary application 210 (e.g., web browser, smartphone app, computer program, etc.) running on an exemplary augmented smartphone 100 and an exemplary application server 103 (e.g., Facebook, Google, etc.), using two or more mobile broadband access devices 101. As explained earlier, the augmented smartphone 100 is configured such that network data in both directions transits through a relay machine 102 which receives and sends said data from and to the augmented smartphone 100 over all of said augmented smartphone's 100 network connections, available through the corresponding mobile broadband access devices 101, and sends and receives said data to and from the application server 103 over a single high speed landline connection. The data sent and received by the application 210 and by the application server 103 is sent and received using an original protocol (e.g., TCP, UDP, ICMP, etc.), while the data exchanged between the augmented smartphone 100 and the relay machine 102 is exchanged using the connection-merging protocol. Both the augmented smartphone 100 and the relay machine 102 are configured to understand and implement said protocol, which allows them to exchange a single stream of data over several mobile broadband connections simultaneously, yielding a higher bandwidth and increased reliability compared to conventional, single-mobile-connection communication.

In the preferred embodiment, the augmented smartphone 100 is configured so as to run three software programs 200-201-202 of interest, while the relay machine 102 runs two corresponding software programs 203-204. In the following, the flow of network data and the behavior of the different software programs are detailed.
The application 210 running on the augmented smartphone 100 makes a conventional network request directed at the application server 103 using an arbitrary network protocol (e.g., TCP, UDP, ICMP, etc.). In order for network requests originating from the application 210 to be transmitted over the augmented smartphone's 100 multiple Internet connections concurrently, the requests undergo a processing, carried out by three computer programs 200-201-202 which the augmented smartphone 100 is configured to run.
The first computer program 200 intercepts the network request and redirects it to a local port on the augmented smartphone 100 on which the second computer program 201 is listening.
The second computer program 201 further alters the network request such that the augmented smartphone's 100 assigned relay machine 102 acts as its proxy, and forwards it to said relay machine 102 for said relay machine 102 to complete the network request and return the application server's 103 network response.
As the network request exits the augmented smartphone 100, the third computer program 202 intercepts it and modifies it to support the connection-merging protocol such that the augmented smartphone's 100 multiple Internet connections are utilized concurrently to transmit the network request. The third computer program 202 then chooses how much of each of the augmented smartphone's 100 Internet connections to use to transmit the network request to the relay machine 102 based on one or more properties (e.g., latency, available bandwidth, reliability, cost, etc.) of each of the connections, and transmits the network request accordingly.
The relay machine 102 receives the network request through its single, Internet-facing network interface, but from multiple source IP addresses. All network requests received by the relay machine 102 from the augmented smartphone 100 are handled by two computer programs 203-204. The first computer program 203, analogously to the third computer program 402 running on the augmented smartphone 100, synchronizes and reassembles partial network requests received over the multiple Internet connections, and recreates the original network request with its original network protocol (e.g., TCP, UDP, ICMP, etc.) so that it can be processed by the application server 103 (which does not implement the connection-merging protocol). Then, the first computer program 203 hands off the request to the second computer program 204.
The second computer program 204 operates in tandem with the second computer program 201 running on the augmented smartphone 100. Together, they carry out the proxying of the network request. The second computer program 204 transmits the network request to the application server 103 over the relay machine's 102 single Internet connection on its single network interface.
The application server 103 receives the network request, processes it as it would any conventional request, and transmits a network response back to the relay machine 102 over the single Internet connection that connects the relay machine's 102 single network interface to the application server 103,
The second computer program 204 running on the relay machine 102 receives the network response from the application server 103, recognizes that the network response is intended for the augmented smartphone 100, and forwards it to said augmented smartphone 100 to return the application server's 103 network response to the application 210.
As the network response exits the relay machine 102, the first computer program 203 intercepts it and modifies it to support the connection-merging protocol such that the augmented smartphone's 100 multiple Internet connections are utilized concurrently to transmit the network response. The first computer program 203 then chooses how much of each of the augmented smartphone's 100 Internet connections to use to transmit the network response to the augmented smartphone 100 based on one or more properties (e.g., latency, available bandwidth, reliability, cost, etc.) of each of the connections, and transmits the network response accordingly.
The third computer program 202 running on the augmented smartphone 100 receives the network response over the augmented smartphone's 100 multiple Internet connections. It synchronizes and reassembles partial network responses received over each of the Internet connections, and recreates the original network response with its original network protocol (e.g., TCP, UDP, ICMP, etc.) so that it can be processed by the application 210. Then, the third computer program 202 hands off the network response to the second computer program 201.
The second computer program 201 recognizes that the network response is intended for the application 210 and hands it off to the first computer program 200.
The first computer program 200 transmits the network response to the application 210, thereby completing the network request and response process between the application 210 running on the augmented smartphone 100 and the application server 103.

The aforementioned software programs 200-201-202-203-204 are software programs that implement the protocols and method described in this disclosure and that allow the augmented smartphone 100 to be configured so as to send and receive a single stream of data to and from a single conventional application server 103 over two or more mobile broadband access devices 101 simultaneously. It should be understood that the number, the nature of the implementation and the order of execution of said computer programs are all irrelevant to this invention; for instance, on the augmented smartphone 100, the third computer program 202, which in the above description is responsible for the use of the connection-merging protocol, can be executed before the second computer program 201 which achieves the proxying of the network request through the relay machine 102, without any impact on the core functionality of said augmented smartphone 100. For this reason, the number of software programs, the nature of their implementation and the order of their execution is not a focus of the claims or embodiments; rather, the claims and embodiments focus on the high-level method or logic performed by said computer programs, which constitutes a crucial component of this disclosure. The number and operation of said programs during an example of network data exchange in the preferred embodiment is exposed above solely in view of offering a detailed description of the method and protocols that the augmented smartphone 100 is configured to implement and that make the described improvements possible. Additionally, and as depicted in FIG. 1, there may be two or more applications 210 running on the augmented smartphone 100, each of which may be exchanging network data with two or more application servers 103, and said data may transit through two or more relay machines 102. Similarly, each relay machine 102 may be handling data exchanges between two or more applications 210 running on two or more augmented smartphones 100 and destined to two or more application servers 103. The described flow of network data between the augmented smartphones 100 and the application servers 103 extends to these more complex network topologies without alteration.

Throughout this disclosure and in the following, it is important to note that the discussed embodiments and the technology they require or utilize for normal operation may change in the future as technology evolves and improves. The invention and its different embodiments still operate without change even in cases where components are replaced with more recent or advanced components that serve the same purpose. As such, the particulars of the components may change and the names that are used to describe them originate from the state of the art and should by no means be considered limiting. Modifications in name or improvement in function shall be of minor influence on the operation of the invention.

Additionally, in the previous and following embodiments, the unmodified devices (e.g., smartphones, tablets, laptops, mobile WiFi hotspots, etc.) already contain all the following peripheral components: a WiFi adapter 121, a battery 124, a processing unit 126, a graphics processing unit 127, a memory unit 128 and a storage unit 129. However, and although it is not explicitly stated, in the event one or more of these components is absent, the configuration that augments said devices may require the incorporation of such to ensure that the operational process as described is possible.

In the following, the disclosure describes alternate embodiments of the augmented device 100 as well as the different configuration concerns arising from augmenting different devices (e.g., tablets, laptops, mobile WiFi hotspots, etc.), and focuses only on the entailed differences with the preferred embodiment (where the original device is a smartphone). In particular, for all of the following embodiments, the described hardware and software configuration and concerns for RF isolation, power and heat management, as well as connection-merging protocol support and communication with the different components in the system still holds and is unaffected.

In one embodiment of the invention, the augmented device 100 is an augmented tablet 100. Tablets equipped with a mobile broadband access device 101 and corresponding digital identity have been known to exist. As such, the same hardware and software configuration and augmentation procedure described for a smartphone is applied to a tablet by tweaking its design to possess two or more mobile broadband access devices 101 and corresponding identities, by enabling the tablet to communicate and interact with the other components (i.e., the relay machines 102 and the coordination machine 104) in the system and by giving it support for the connection-merging protocol to, preferably, exchange data with conventional application servers 103 while benefiting from the use of a plurality of mobile broadband technologies (e.g., 2G, GSM/GPRS/EDGE, 3G WCDMA/HSPA+, 4G LTE/WiMAX, 5G LTE-A, etc.) and/or infrastructures (of different mobile network operators) simultaneously.

In another embodiment of the invention, the augmented device 100 is an augmented laptop 100. Laptops equipped with a mobile broadband access device 101 and corresponding digital identity have been known to exist. As such, the same hardware and software configuration and augmentation procedure described for a smartphone is applied to a laptop by tweaking its design to possess two or more mobile broadband access devices 101 and corresponding identities, by enabling the laptop to communicate and interact with the other components: (i.e., the relay machines 102 and the coordination machine 104) in the system and by giving it support for the connection-merging protocol to, preferably, exchange data with conventional application servers 103 while benefiting from the use of a plurality of mobile broadband technologies (e.g., 2G, GSM/GPRS/EDGE, 3G WCDMA/HSPA+, 4G LTE/WiMAX, 5G LTE-A, etc.) and/or infrastructures (of different mobile network operators) simultaneously. Additionally, and because laptops are typically bigger in surface, an augmented laptop 100 may contain a total of more than three mobile broadband access devices 101 without any significant repercussions on the comparative size of said augmented laptop 100 compared to its conventional counterpart.

In another embodiment of the invention, the augmented device 100 is an augmented mobile WiFi hotspot 100. Mobile WiFi hotspots are conventionally equipped with a single mobile broadband access device 101 and corresponding digital identity. As such, the same hardware and software configuration as well as augmentation procedure described for a smartphone is applied to a mobile WiFi hotspot by tweaking its design to possess two or more mobile broadband access devices 101 and corresponding identities, by enabling the mobile WiFi hotspot to communicate with and interact with the other components (i.e., the relay machines 102 and the coordination machine 104) in the system and by giving it support for the connection-merging protocol to, preferably, exchange data with conventional application servers 103 while benefiting from the use of a plurality of mobile broadband technologies (e.g., 2G, GSM/GPRS/EDGE, 3G WCDMA/HSPA+, 4G LTE/WiMAX, 5G LTE-A, etc.) and/or infrastructures (of different mobile network operators) simultaneously. Moreover, and because mobile WiFi hotspots typically act as Internet gateways for separate, unmodified devices, an additional subtle but crucial modification needs to be performed, which is discussed below.

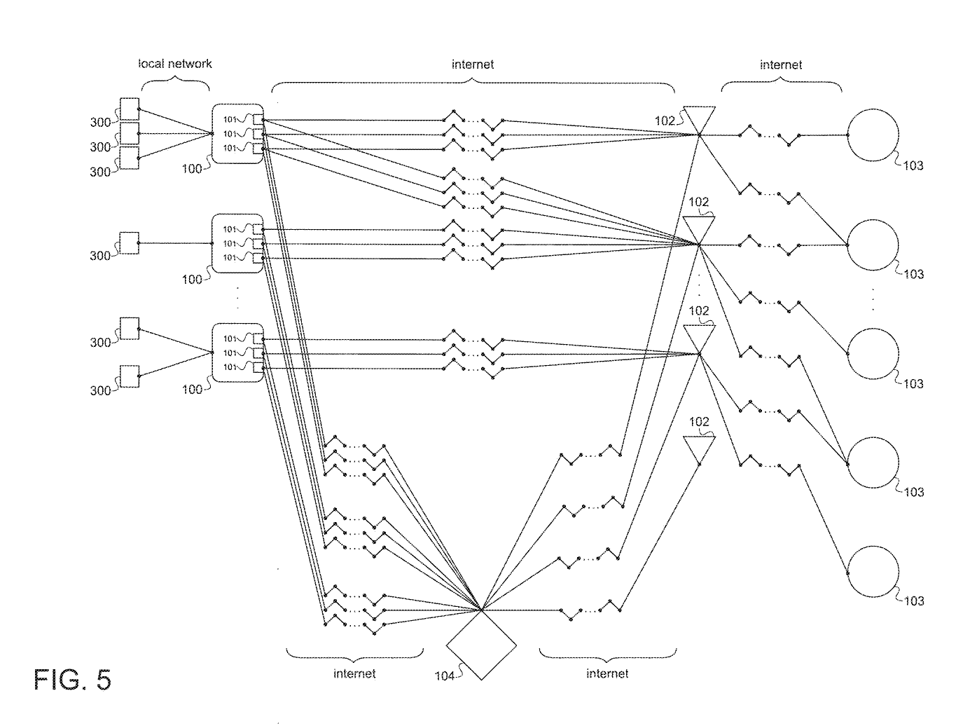

As illustrated in FIG. 5, in some alternate embodiments, the augmented device 100 may act as a gateway to the Internet for separate, unmodified client devices 300. In such an embodiment, the client devices 300 are connected to the augmented device 100 via a local network, typically through an Ethernet or WiFi connection, and use this local connection to route their network traffic to the Internet. It is important to note that while the embodiment where the augmented device 100 is a gateway was introduced by the embodiment where the augmented device 100 is a mobile WiFi hotspot, any other augmented device 100 (e.g., smartphone, tablet, laptop, etc.) may act as a gateway to separate client devices 300 using a configuration commonly referred to in the art as tethering, as long as it possesses, in addition to the mobile broadband access devices 101, the necessary components to establish a local network connection (e.g., Ethernet port, WiFi module, etc.) with separate client devices 300. It is also important to note that the topology of the connection between a client device 300 and the augmented device 100 acting as its gateway may contain several intermediate network routing apparatuses (e.g., network router, network switch, WiFi range extender, etc.).

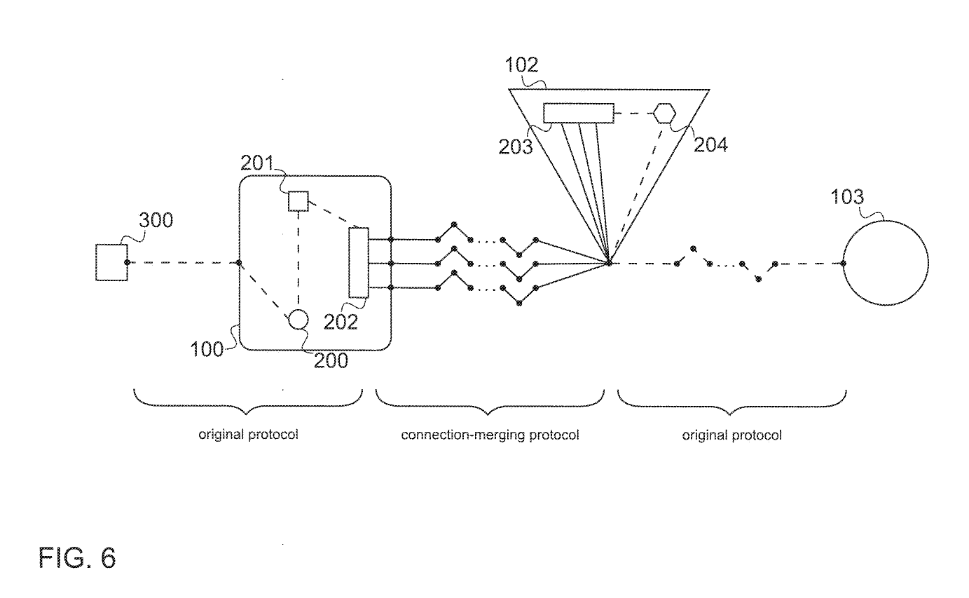

In such an embodiment, and as illustrated in FIG. 6, the notable differences in the behavior of the augmented software and corresponding flow of network data described above, are that the conventional network request destined to an application server 103, instead of originating from an application 210 running on the augmented device 100, now originates from a client device 300 connected to the augmented device 100 via a local network connection, and that the corresponding conventional network response from the application server 103 is destined to the client device 300 connected to the augmented device 100 via a local network connection instead of being destined to an application 210 running on the augmented device 100. As such, the first computer program 200 that runs on the augmented device 100, in order to seamlessly handle the configuration where said augmented device 100 acts as a gateway to separate, conventional client devices 300, is configured to not only intercept, redirect and transmit network requests originating from and/or destined to applications 210 running on the augmented device 100 itself, but also to intercept, redirect and transmit network requests which are being routed by the augmented device 100, and originating from and/or destined to said conventional client devices 300 connected to said augmented device 100 through a local network connection. In such an embodiment, the conventional client devices 300, similarly to the applications 210 running on the augmented device 100, remain oblivious to the existence of the non-conventional connection-merging protocol, relay machines 102 and coordination machine 104 that sit between them and the application servers 103.

In another embodiment of the invention, one or more of the software applications 210 running on the augmented device 100 and/or one or more of the client devices 300 tethering their Internet traffic through the augmented device 100 are explicitly configured to proxy their Internet traffic through the relay machine 102 assigned to the augmented device 100 by the coordination machine 104. By doing so, the processing, memory and disk resources consumed by the first and second computer programs 200-201 running on the augmented device 100 may be freed, and as a direct consequence heat emissions and power consumption are reduced, leading, when the augmented device 100 is battery powered (e.g., smartphone, tablet, laptop, mobile WiFi hotspot, etc.), to a longer battery life. In such an embodiment, the software configuration of the augmented device 100 does not reside at the operating system level and is not transparent to the user, software applications 210, and/or client devices 300.

In yet another embodiment, one or more of the two or more mobile broadband access devices 101 are dynamically configured to operate in a diminished state (e.g., operating on older technologies only, operating at lower radio wave intensities, operating in a latency-monitoring mode, etc.) according to a set of metrics based on processing, memory, disk, individual connection latency, individual connection bandwidth, power consumption, and/or, when the augmented device 100 is battery powered (e.g., smartphone, tablet, laptop, mobile WiFi hotspot, etc.), battery charge measurements. These metrics are designed to offer a trade-off between the additional bandwidth, coverage and reliability offered by said one or more mobile broadband access devices 101, and the additional resources they consume: By configuring said one or more mobile broadband access devices 101 to operate in a diminished state, part of the processing, memory and disk resources consumed by said one or more mobile broadband access devices 101 are freed, and as a direct consequence heat emissions and power consumption are reduced, leading, when the augmented device 100 is battery powered (e.g., smartphone, tablet, laptop, mobile WiFi hotspot, etc.), to a longer battery life. Additionally, part of the RF emissions generated by said one or more mobile broadband access devices 101 vanish, and as a result less RF interference is observed. In such an embodiment, said one or more mobile broadband access devices 101 are typically configured to operate in a diminished state when the mobile broadband connections provided by said one or more mobile broadband access devices 101 have a significantly higher latency and/or a significantly lower bandwidth compared to that of the mobile broadband connections provided by the remaining mobile broadband access devices 101, when the aforementioned resources are limited, and/or, in cases where the augmented device 100 is battery powered (e.g., smartphone, tablet, laptop, mobile WiFi hotspot, etc.), when the battery charge is low.

In another embodiment of the invention, the augmented device 100 is configured such that each mobile broadband access device 101 has access to a plurality of digital, physical or virtual, identities. Each of the two or more mobile broadband access devices 101 is then dynamically associated with one of the two or more digital identities that are accessible to it to connect to one of the networks of different network operators according to a variety of parameters, such as geographical location, list of available operators, data rates with the different operators, etc. In this embodiment, the augmented device 100 is not only capable of providing faster and more reliable mobile broadband access, but also roaming-free mobile broadband access by equipping the augmented device 100 with digital identities from two or more mobile network operators from two or more countries, and by using local digital identities whenever possible. In this embodiment, the use of multiple identities over a single mobile broadband access device 101 may, hardware-wise and when the digital identities are physical, require minor amendments to the mobile broadband access devices 101 as well as to the layout of the augmented device 100. Software-wise, simple software additions to manage the different identities are required. Both amendments are discussed below, however, all of the hardware and software concerns as well as solutions discussed above remain unchanged. In practice, and when the digital identities are physical, each mobile broadband access device 101, instead of being connected to a single digital identity, is connected to a physical multiplexer connecting said mobile broadband access device 101 to one digital identity at a time. In turn, the added digital identities are chosen and laid out in an arrangement that minimizes space occupancy according to the shape and form of the augmented device 100. For instance, if the physical digital identities are SIM cards, nano-SIMs are preferred, and are preferably organized in a vertical arrangement. Accordingly, a simple software API offers control over said physical multiplexer, multiplexer which is operated according to the parameters discussed above. In the case where the digital identities are virtual, the above multiplexing itself as well as the corresponding multiplexer control are handled by the same single software that operates the physical multiplexer described above.

In another embodiment, the augmented device 100 is configured such that two or more of the two or more of the mobile broadband access devices 101 are equipped with digital identities from the same operator. In such a scenario, the mobile broadband access devices 101 are configured and programmed to utilize distinct frequency band channels 402 whenever possible such as to maximally reduce the likelihood of the mobile broadband access devices 101 competing for the same network resources (e.g., network capacity and bandwidth of a single frequency band channel 402) as well as to minimize the likelihood of interference between the mobile broadband access devices 101. In one such example, one of the mobile broadband access devices 101 supports LTE and another, one supports WiMAX, both of which are equipped with digital identities to connect to each technology of the same operator, assuming said technologies are being operated by the same operator on different frequency band channels. In that example, while several mobile broadband access devices 101 are equipped with digital identities from the same operator, said mobile broadband access devices 101 are not competing for the same network resources as the two technologies (LTE and WiMAX) are operated on different frequency band channels 402. In another such example, one of the mobile broadband access devices 101 supports LTE and another one supports 3G, both of which are equipped with digital identities to connect to each technology of the same operator, assuming said technologies are being operated by the same operator on different frequency band channels. In that example, while several mobile broadband access devices 101 are equipped with digital identities from the same operator, said mobile broadband access devices 101 are not competing for the same network resources as the two technologies (LTE and 3G) are operated on different frequency band channels 402. In yet another such example, two or more of the mobile broadband access devices 101 support LTE and are provided with digital identities to connect to the same operator, assuming said LTE technology is being operated by said operator on at least as many different frequency band channels as there are such mobile broadband access devices 101. In turn, and in order to avoid competing for the same network resources (e.g., network capacity and bandwidth of a single frequency band channel 402), said mobile broadband access devices 101 are configured so as to each connect to a different LTE frequency band channel 402 of said operator whenever possible.

In alternate embodiments, the augmented device 100 is configured such that the digital identities used by the mobile broadband access devices 101 are any mixture of SIM cards, virtual SIMs, WiMAX credentials, Remote Authentication Dial-In User Service (RADIUS) credentials or any different current or future technologies that achieve the same purpose: identifying a user to a network and granting them access to it. Accordingly, the mobile broadband access devices 101 are chosen to support any mixture of GSM, GPRS, EDGE, WCDMA, HSPA, DC-HSPA, WiMAX, LTE, LTE-A, WiFi, LiFi or any different current or future technologies that achieve the same purpose: offering mobile broadband connectivity to a device. It should be understood that the number of digital identities used by each mobile broadband access device 101, the number of mobile broadband access devices 101 using a digital identity, the nature of said digital identity, the nature of the technology supported by each of the mobile broadband access device 101, and the infrastructure supporting said technology may all vary without departing from the scope of this invention. In one such example, one single digital identity is shared by two or more mobile broadband access devices 101 to access the networks of one or more mobile network operators.

In other embodiments, one or more of the two or more mobile broadband connections and their corresponding mobile broadband access devices 101 and digital identities are replaced by wired broadband connections (e.g., Fibre-optic, Digital Subscriber Line (DSL), Dial-up, etc.) and their corresponding wired broadband access facilities (e.g., Ethernet port, DSL port, telephone port, etc.). In one such embodiment, the augmented device 100 is an augmented mobile WiFi hotshot that contains one or more mobile broadband access devices 101 and one or more wired broadband access facilities and that combines the bandwidth and reliability of one or more mobile broadband connections and one or more wired broadband connections when the said wired broadband connections are available, and that combines the bandwidth and reliability of only the one or more mobile broadband connections when on the go. Such an embodiment offers an interesting out-of-the-box solution to the problem that is referred to in the art as the last mile, by allowing a single user to benefit from the use of any and all available Internet infrastructure around them in areas where said infrastructure is limited and fragmented.

In other embodiments, the RF isolating and heat-dissipating elements are composed of different metals or employ different technologies than those described in the preferred embodiment. In one such embodiment, and depending on the size constraints of the augmented device 100 (a smartphone has more size constraints than a laptop), passive heat sinks (i.e., finned aluminum alloy or copper structures) or active heat sinks (i.e., fan-based heat sinks) are added to dissipate the additional heat. It should be understood that such embodiments or variations thereof still fall under the scope of this invention as the achieved result is inherently the same: optimally designing the layout and arranging the components such that two or more mobile broadband access devices 101 operate independently of one another, possibly simultaneously, while limiting additional interference and heat generation compared to that observed with the original device that is being augmented.

In another embodiment, the functionality of two or more of the two or more mobile broadband access devices 101 is performed by one single component or module which allows the simultaneous establishment of and the simultaneous exchange of network data over two or more mobile broadband connections using the infrastructures of one or more mobile network operators with a corresponding set of digital, physical or virtual identities. Said device or module may for instance allow the sharing of one or more of the following components which are typically individually present in each of the mobile broadband access devices 101: the power management unit, the processing unit, the one or more antennas, etc., in order, for instance, to achieve one or more of the following benefits: lower the power consumption, lower the heat emissions, lower the size occupied by the mobile broadband access devices 101, etc. It should be understood that such an embodiment or variations thereof still fall under the scope of this invention as the achieved functionality is inherently the same.

In another embodiment of the invention, the augmented device 100 is a novel device (i.e., produced using original designs, schematics, hardware and/or software rather than by modifying and augmenting those of an existing device) that incorporates the disclosed hardware and software additions as well as disclosed coexistence and cooperation with the other components in the system. This disclosure is positioned as a way of augmenting designs for existing devices in order to stress the wide industrial applicability and repercussions of the disclosed invention, and in order to protect its inventors from what is anticipated to be the nature of short term infringements. It should be understood however that a novel device incorporating the disclosed hardware additions such as the two or more mobile broadband access devices 101, as well as software additions such as the support for the connection-merging protocol, and interactions with the other components in the system such as the proxying of data through a relay machine 102 assigned to the augmented device 100 by the coordination machine 104, does fall under the scope of this disclosure.

In another embodiment, the coordination machine 104 dynamically assigns two or more relay machines 102 to each of the augmented devices 100. In such an embodiment, additional information is transmitted by the coordination machine 104 to enable the user or augmented device 100 to dynamically select the relay machine 102 said augmented device 100 uses as a proxy for data it exchanges with one or more conventional application servers 103. In one such example, said additional information comprises the geographical location of each of said two or more assigned relay machines 102, and said selection mechanism is performed either by the user to obtain a custom experience based on the geographical location of the selected relay machine 102, or by the augmented device 100 to, for instance, minimize the latency between said one or more conventional application servers 103 and the selected relay machine 102. Said selection is driven by instructions sent by the coordination machine 104 (e.g., each of the assigned relay machines 102 is associated with an application server 103 IP range or region), or by the augmented device 100 (e.g., the relay machine 102 is selected dynamically based on the data being exchanged and the application server 103 it is being exchanged with).

In other embodiments, the coordination machine 104 does not dynamically assign a relay machine 102 to each of the augmented devices 100; instead, one or more identities are used by each augmented device 100 to identify one or more relay machines 102, each of said one or more identities being subsequently mapped to a relay machine 102 dynamically. In one such embodiment, this mechanism is implemented using a domain name as said identity, and a Domain Name Server (DNS) to perform said dynamic mapping. Said DNS is part of or separate from the coordination machine 104, which dictates the logic behind said mapping according to the aforementioned metrics.

In other embodiments, the functionality achieved by the coordination machine 104, the pool of relay machines 102 it controls and the augmented devices 100 that proxy their traffic through them is performed by differing network topologies, software implementations and/or hardware configurations. Namely, the functions of the coordination machine 104 are implemented as one or more peer-to-peer, decentralized and/or distributed computer programs running on one or more physical or virtual machines, which do or do not coincide with the relay machines 102, in order to increase the overall system's robustness to coordination machine 104 failures and/or performance limitations. Similarly, the relay machines 102 are physical or virtual, and they are located either at the base stations 400 or deeper within the Internet and closer to the application servers 103. Lastly, the augmented devices 100 interacting with said relay machines 102 and coordination machine 104 are a mixture of one or more of: augmented smartphones 100, augmented tablets 100, augmented laptops 100, augmented mobile WiFi hotspots 100, novel devices 100, etc., each tethering their client devices' 300 traffic and/or communicating with application servers 103 directly. It should be understood that such embodiments or variations thereof still fall under the scope of this disclosure as the achieved behavior is inherently the same, and that the invention is not restricted by the hardware configuration and/or software architecture of the computer programs that carry out the functions of the coordination machine 104, relay machines 102, and/or augmented devices 100.

The way of configuring a network-enabled device in a system containing a coordination machine 104 and one or more relay machines 102, resulting in an augmented device 100 capable of intelligently-enabled communication with at least one conventional application server 103 over multiple segments of the Internet concurrently can be summarized as follows; the original device (e.g., smartphone, tablet, laptop, mobile WiFi hotspot, etc.) possesses a plurality of components, typically including a circuit board 125 to which the following components are either mounted on or connected to: a processing unit 126, a memory unit 128, a storage unit 129, a GPS 120, a WiFi adapter 121, a rechargeable battery 124, a graphics processing unit 127 and possibly a mobile broadband access device 101; the original device is augmented to possess two or more: mobile broadband access devices 101 each equipped with their own digital identity, each able to operate independently and all configured and programmed such as to connect to disjoint frequency band channels 402; the original device is additionally augmented such that the augmented device 100 cooperates with the other components of the system, namely relay machines 102 that act as proxies between the augmented devices 100 and conventional network-enabled application servers 103, as well as the coordination machine 104 which aggregates status and routing information relevant to the augmented devices 100 and relay machines 102, and dynamically adjusts the number, location and/or performance specifications of running relay machines 102; the original device, in order to allow said communication over multiple segments of the Internet concurrently, is also augmented such that the augmented device 100 uses a connection-merging protocol which is also known to the relay machines 102. Said configuration results in the augmented device 100 described throughout this invention, which typically utilizes two or more mobile broadband connections using similar mobile broadband technologies (e.g., GSM/GPRS/EDGE, 3G WCDMA/HSPA+/DC-HSPA+, 4G LTE/WiMAX, 5G LTE-A, etc.) over distinct infrastructures (of different mobile network operators) simultaneously in order to offer the same network access facilities as the original device with the added benefits of increased reliability, coverage and throughput.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes, which come within the meaning and range of equivalency of the claims, are to be embraced within their scope. Additionally, in the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

1. A way of configuring a device by modifying and augmenting its designs, schematics, hardware and/or software, and by integrating it into a system, resulting in an augmented device capable of demand-driven, flexible topology and intelligently-enabled communication with at least one conventional application server over multiple segments of the Internet concurrently, where:
the augmented device is configured to possess a processing unit, a memory unit, a storage unit, as well as two or more mobile broadband access devices;
the augmented device is configured to coexist and cooperate with the other components of the system comprising other augmented devices, a dynamic pool of relay machines that act as proxies between one or more augmented devices and one or more application servers, as well as a coordination machine that aggregates status and routing information relevant to the augmented devices and relay machines, and dynamically adjusts the number, location and/or performance specifications of running relay machines; and
the augmented device is configured to proxy data it exchanges with said at least one application server through one of the relay machines using a connection-merging protocol which is also known to said relay machines.

2. The configuration of claim 1 where the augmented device is configured to possess additional RF- and heat-isolating elements.

3. The configuration of claim 1 where the augmented device is configured to possess different power management components, and/or a battery with a higher capacity.

4. The configuration of claim 1 where the augmented software functionality of the augmented device operates transparently to its software applications and to the end-user.

5. The configuration of claim 1 where the augmented software functionality of the augmented device is partly or entirely implemented within its operating system.

6. The configuration of claim 1 where the connection-merging protocol operates at Layer 4 of the Open Systems Interconnection model.

7. The configuration of claim 1 where the coordination machine dynamically assigns a relay machine to each of the augmented devices.

8. The configuration of claim 1 where the augmented devices and the relay machines exchange location and/or performance information with the coordination machine.

9. The configuration of claim 1 where the connection-merging protocol is also known to the coordination machine, and data exchanged between the augmented device and the coordination machine uses the connection-merging protocol.

10. The configuration of claim 1 where the coordination machine adjusts the number and/or performance attributes of the relay machines as well as their association with the augmented devices so as to maximize the bandwidth made available by each relay machine to each of its connected augmented devices, minimize the latency of the network connections between each relay machine and each of its connected augmented devices, and/or minimize the cost of operating the system.

11. The configuration of claim 1 where the augmented device acts as a gateway to the Internet for one or more separate, unmodified client devices and transparently allows each of them to communicate with at least one conventional application server over multiple segments of the Internet concurrently.

12. The configuration of claim 1 where a data exchange between, on the first hand, a software application running on the augmented device or a client device routing its Internet traffic through the augmented device, and, on the second hand, a conventional application server, follows the following steps:
the software application or the client device makes a conventional network request directed at the application server;
the augmented device intercepts the network request, modifies it to support the connection-merging protocol, and transmits the modified network request for proxying to one of the relay machines over its two or more mobile broadband connections;
the relay machine synchronizes and reassembles the modified network request received over the two or more mobile broadband connections, recreates the original network request, and transmits the original network request to the application server;
the application server receives the network request and transmits a conventional network response back to the relay machine;
the relay machine receives the network response from the application server, modifies it to support the connection-merging protocol, and transmits the modified network response to the augmented device over its two or more mobile broadband connections;
the augmented device synchronizes and reassembles the modified network response received over its two or more mobile broadband connections, recreates the original network response, and transmits the original network response to the software application or the client device; and
the software application or the client device receives the network response.

13. The configuration of claim 1 where one or more of the software applications running on the augmented device and/or one or more of the client devices routing their Internet traffic through the augmented device are explicitly configured to proxy their Internet traffic through one of the relay machines.

14. The configuration of claim 1 where one or more of the mobile broadband access devices are dynamically configured to operate in a diminished state.

15. The configuration of claim 1 where the mobile broadband access devices are configured and programmed to utilize distinct frequency band channels.

16. The configuration of claim 1 where the digital identities used by the mobile broadband access devices are physical or virtual SIMs.

17. The configuration of claim 1 where the digital identities used by the mobile broadband access devices provide access to the mobile networks of two or more distinct network operators.

18. The configuration of claim 1 where the digital identities used by two or more of the mobile broadband access devices provide access to the mobile network of the same operator.

19. The configuration of claim 1 where at least one of the mobile broadband access devices has access to two or more digital identities and is dynamically associated to one of said identities.

20. The configuration of claim 1 where the digital identities used by the mobile broadband access devices are a mixture of physical and/or virtual network identification credentials.

21. The configuration of claim 1 where the mobile broadband access devices support a mixture of distinct mobile broadband technologies.

22. The configuration of claim 1 where one or more of the mobile broadband access devices are replaced by wired broadband access facilities.

23. The configuration of claim 1 where one single digital identity is shared by two or more of the mobile broadband access devices.

24. The configuration of claim 1 where the functionality of two or more of the mobile broadband access devices is performed by one single component or module.

25. The configuration of claim 1 where the augmented device is a novel device that incorporates the disclosed hardware and software additions and that coexists and cooperates with the other components of the system in the disclosed manner.

26. The configuration of claim 1 where the functions of the coordination machine are distributed onto one or more physical or virtual machines.

27. The configuration of claim 1 where the relay machines are physical or virtual, and are located at the base stations or deeper within the Internet and closer to the application servers.

28. The configuration of claim 1 where the coordination machine assigns two or more relay machines to each of the augmented devices.

29. The configuration of claim 1 where one or more relay machine identities are used by each augmented device, each of said identities being dynamically mapped to a relay machine.

30. The configuration of claim 1 where the augmented devices in the system are a mixture of augmented smartphones, augmented tablets, augmented laptops, augmented mobile WiFi hotspots, and/or novel devices.
